(19) United States
(12) Patent Application Publication
(10) Pub. No.: US 2013/0114939 A1
(43) Pub. Date: May 9, 2013

(54) Invention title is a digital multi-media keepsake. It is a handheld case with a built in LCD video screen which displays digital photos and plays digital video and audio, with a removable storage container in the center of the case that stores memorabilia, personal items or cremated remains. The keepsake case has internal memory and a USB port installed to add videos, photographs, text and audio between the case and an external device such as a personal computer. The case displays digital photos, plays video and audio automatically when opened and automatically shuts off when closed.

(71) Applicant: Joseph B. Gamboa, Santa Clara, CA (US)

(72) Inventor: Joseph B. Gamboa, Santa Clara, CA (US)

(21) Appl. No.: 13/587,160

(22) Filed: Aug. 16, 2012

Related U.S. Application Data
(60) Provisional application No. 61/555,275, filed on Nov. 3, 2011.

(51) Int. Cl. H04N 9/87

(52) U.S. Cl. CPC H04N 9/87
USPC 386/230

(57) ABSTRACT

It is a handheld digital keepsake case with a built-in video screen which plays video, photos, and audio, with a removable storage container. The exterior case displays digital photos, plays video and audio automatically when opened and shuts off when closed. It is a keepsake within a case that plays digital photos, video and audio files automatically when opened. It can continue to be used by the recipient whenever he or she desires to reflect on the memory of another

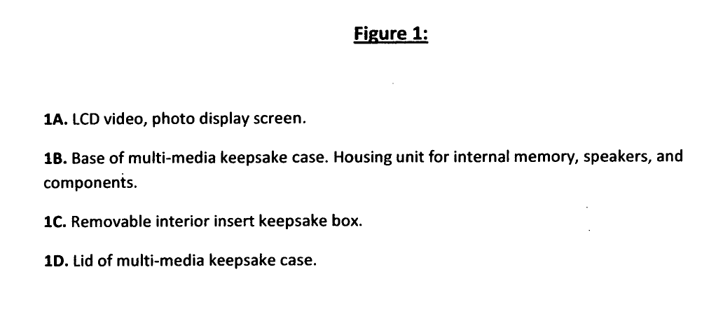

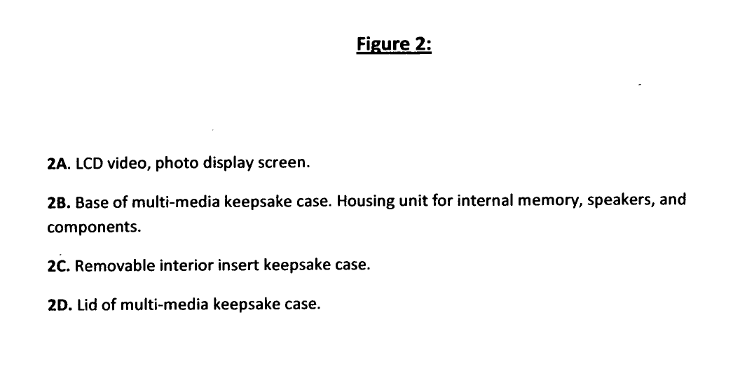

This application claims the benefit of provisional application;
Application No. 61/555,275
Filing Date: Nov. 3, 2011
Present Inventor: Joseph B. Gamboa

The invention title is a digital multi-media keepsake. It is a handheld case with a built in LCD video screen which displays digital photos and plays digital video and audio, with a removable storage container in the center of the case that stores memorabilia, personal items or cremated remains. The keepsake case has internal memory and a USB port installed to add videos, photographs, text and audio between the case and an external device such as a personal computer. The case displays digital photos, plays video and audio automatically when opened and automatically shuts off when closed.

### BACKGROUND OF THE INVENTION

### Problem Solved

Currently video and photo biographies and tributes can be viewed online, on a computer, digital picture frame, cell phone, or with a DVD player only. Conventional keepsakes do not include the use of customized video, photo, text and audio messages that can be preprogrammed and can be displayed on a display LCD screen that is activated when opened. Conventional keepsakes do not include the use of simultaneously displaying customized digital video, digital photos with audio display for the recipient to enhance the memory of a loved one. This handheld case is wireless and cordless and is a portable dedicated device that has an insert case that stores memorabilia, such as cremated ashes or personal keepsake items. It functions as a digital video, photo and audio player when opened.

There are no other video/photo keepsakes with an inserted personal storage container that are cordless which plays digital video, photo, and audio files.

It is a storage container within a case that plays digital photo, video and audio files automatically when opened and automatically shuts off when closed.

### BRIEF SUMMARY OF THE INVENTION

A portable handheld box shaped container that functions as a tribute keepsake displaying digital media files when opened and by storing another inserted container that stores memorabilia.

### DETAILED DESCRIPTION OF THE INVENTION

Currently video and photo biographies and tributes can be viewed online, on a computer, digital picture frame, cell phone or with a DVD player only. This provides a wireless and cordless and portable device that stores memorabilia, such as cremated ashes or keepsake items that functions as a digital video, photo and audio player when opened. The invention claimed here solves this problem.

It provides a cordless dedicated delivery device, with a removable storage case insert that does not require the internet, computer, memory card, or a DVD apparatus to view video and photo files.

The claimed invention differs from what currently exists. Presently there are no portable handheld keepsakes which one can view customized digital video and photos, with an inserted keepsake box. It is a dedicated handheld video and audio case with a built-in insert case that stores memorabilia and personal items.

This invention is an improvement on what currently exists. Presently there are no portable handheld video and photo keepsakes with an inserted personal storage keepsake box. It is a dedicated handheld video and audio case with a built-in insert case that stores memorabilia.

### The Version of the Invention Discussed Here Includes:

1. A wood, metal, plastic, acrylic or ceramic box-case container with built in video screen, built in speaker, and USB connector.
2. Insertable storage container made of wood, plastic, metal, acrylic or bio-degradable material.
   Relationship between the Components:

Item #1 is a container that stores item #2.

Item #2 is a removable storage container that inserts in item #1.

How the Invention Works:

First item #1 must be charged by plugging in a charging adaptor to the built in USB connector. Next a standard USB adaptor should be plugged into item #1 to a Personal computer desktop or laptop. Next, open lid to item #1 to activate, open window on device on personal computer or laptop. Next drag video, picture and or audio files from computer into removable storage device that opens in my computer. Next close lid to item #1 which turns item #1 power off and will close open window on desktop or laptop. Next, click on the close removable storage device icon. Unplug USB connector form computer and device.

Next open lid to item #1 to activate device. Close lid on item #1 to shut off device. Volume control can be adjusted when device is open and plugged into personal or laptop device when removable device window is open. Item #2 should be removed form item #1.

Open lid to item #2 to install any personal items within the size of item#2. Close lid to item #2 to secure personal items. Install item #2 into opening in item #1.

### How to Make the Invention:

1) Select material for item #1 either, wood, metal, plastic, or acrylic. 2) Shape and make mold of item #1. 3) Install software, LCD screen; speaker, USB connector and components. 4) Select material either wood, plastic, metal, ceramic, acrylic or bio-degradable material for item #2. Mold for size to fit into item #1. Insert item #2 into item #1.

Material for item #1 is necessary. Software, LCD screen, speaker, USB connector, and battery are necessary. Material for item #2 is necessary.

The lifespan of rechargeable battery can be extended. The internal memory can be increased. Item #1 and item #2 can be custom painted or wrapped. Customized optional and different materials and sizes can be used for item #1 and item #2.

### How to Use the Invention:

This particular invention is not used to solve a problem. It is a digital photo, video and audio keepsake that offers additional technological features.

Additionally: This device can be used as a container that stores and contains educational material.

1. This invention is a portable box shaped container that stores a smaller keepsake container which stores memorabilia and has a built in video screen and internal speakers that displays customized digital media files, such as video, photo data and audio files when opened to celebrate the memory of a another on demand. Currently handheld keepsakes do not allow personalized and customizable digital media files to be displayed while serving as a storage container for memorabilia.
